(19) United States
(12) Patent Application Publication
(10) Pub. No.: US 2024/0111465 A1
(43) Pub. Date: Apr. 4, 2024

(54) IMAGE FORMING APPARATUS, NON-TRANSITORY COMPUTER READABLE MEDIUM STORING PROGRAM, AND IMAGE FORMING METHOD

(71) Applicant: FUJIFILM Business Innovation Corp., Tokyo (JP)

(72) Inventors: Ai NAKAO, Kanagawa (JP); Haruhiko KOJIMA, Kanagawa (JP); Joji SAITO, Kanagawa (JP); Makoto ITO, Kanagawa (JP)

(73) Assignee: FUJIFILM Business Innovation Corp., Tokyo (JP)

(21) Appl. No.: 18/189,200

(22) Filed: Mar. 23, 2023

(30) Foreign Application Priority Data
Sep. 26, 2022 (JP) 2022-152951

(51) Int. Cl. G06F 3/12

(52) U.S. Cl. CPC G06F 3/1234; G06F 3/121; G06F 3/1273

(57) ABSTRACT

An image forming apparatus includes a processor configured to display a clearing method for clearing an initial error among errors that have occurred, on a display part, while the clearing method of the initial error of which the clearing method is displayed on the display part is displayed, receive a temporary clearing instruction for processing the initial error as being temporarily cleared, each time the temporary clearing instruction is received, display clearing methods of subsequent errors on the display part in order in a switched manner, and in a case where clearing operations for all clearing methods of the errors that have occurred are completed, resume processing of a job paused by the errors.

### CROSS-REFERENCE TO RELATED APPLICATIONS

This application is based on and claims priority under 35 USC 119 from Japanese Patent Application No. 2022-152951 filed Sep. 26, 2022.

### BACKGROUND

### (i) Technical Field

The present invention relates to an image forming apparatus, a non-transitory computer readable medium storing a program, and an image forming method.

### (ii) Related Art

JP1994-052018A discloses an error display method in which a display device, an error detection section, and an error display control section are provided, and in which an error is detected and an error message is displayed on a display screen. In the error display method, a display priority order is assigned to each error. In a case where a plurality of errors occur at the same time, or in a case where a different error occurs during error display, an error message corresponding to an error having a highest priority order is displayed.

JP2011-138394A discloses an information processing apparatus including an instruction section that instructs an image forming apparatus to execute a job, a reception section that, in a case where an error occurs in the image forming apparatus during the execution of the job that the image forming apparatus is instructed to execute by the instruction section, receives error information indicating that the error has occurred, a display section that displays the error information, an acquisition section that acquires information indicating that the image forming apparatus is instructed to execute the job by skipping the error, a determination section that, in a case where the information is acquired by the acquisition section, determines whether or not to continue displaying the error information displayed on the display section depending on a type of the error, and a control section that, in a case where a determination to continue displaying the error information displayed on the display section is made by the determination section, continues displaying the error information displayed on the display section and that, in a case where a determination not to continue displaying the error information displayed on the display section is made, stops displaying the error information displayed on the display section.

### SUMMARY

There is an image forming apparatus that, in a case where a plurality of errors occur, displays one clearing method for one error and that, in a case where a clearing operation indicated by the displayed clearing method is checked, displays a subsequent clearing method of a subsequent error and checks a clearing operation indicated by the clearing method for the subsequent error.

In the image forming apparatus, a corresponding clearing operation is checked for each error. For example, the checking of the clearing operation is triggered by opening and closing of a cover. Accordingly, even in a case where a plurality of clearing operations are performed at the same time, an opening and closing operation of the cover as the trigger needs to be performed the number of times corresponding to the number of errors, and the checking of the plurality of clearing operations cannot be collectively performed.

Aspects of non-limiting embodiments of the present disclosure relate to an image forming apparatus, a non-transitory computer readable medium storing a program, and an image forming method that can collectively check a plurality of clearing operations for a plurality of errors.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including a processor configured to display a clearing method for clearing an initial error among errors that have occurred, on a display part, while the clearing method of the initial error of which the clearing method is displayed on the display part is displayed, receive a temporary clearing instruction for processing the initial error as being temporarily cleared, each time the temporary clearing instruction is received, display clearing methods of subsequent errors on the display part in order in a switched manner, and in a case where clearing operations for all clearing methods of the errors that have occurred are completed, resume processing of a job paused by the errors.

### BRIEF DESCRIPTION OF THE DRAWINGS

Exemplary embodiment(s) of the present invention will be described in detail based on the following figures, wherein:

FIG. 1 is a schematic perspective diagram of an image forming apparatus according to an exemplary embodiment of the present invention;

FIG. 2 is a schematic block diagram of the image forming apparatus according to the exemplary embodiment of the present invention;

FIG. 3 is a description diagram illustrating an example of a database of errors according to the exemplary embodiment of the present invention; and

FIG. 4 is a flowchart illustrating an example of a flow of processing in clearing the errors according to the exemplary embodiment of the present invention.

### DETAILED DESCRIPTION

### Exemplary Embodiment

Hereinafter, an example of an exemplary embodiment of the present disclosure will be described with reference to the drawings. In each drawing, identical or equivalent constituents and parts are designated by identical reference signs. In addition, dimensional ratios in the drawings are exaggerated for convenience of description and may be different from actual ratios.

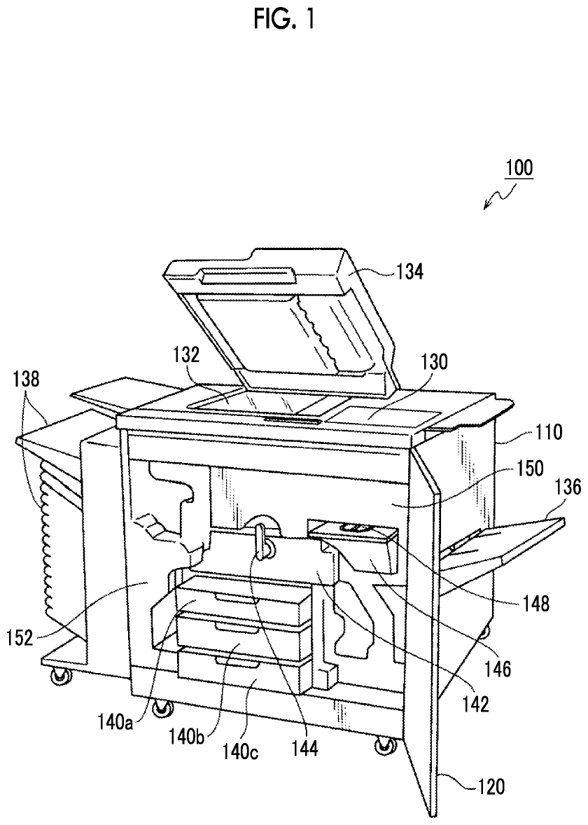

FIG. 1 is a perspective exterior diagram in which an image forming apparatus 100 according to the present exemplary embodiment is seen from a front side. The image forming apparatus 100 according to the present exemplary embodiment has various functions such as a printing function, a copy function, a facsimile function, and a scanner function.

The image forming apparatus 100 in FIG. 1 is provided in a front portion of a body apparatus 110 and includes a front cover 120 through which an inside of the image forming apparatus 100 can be accessed by opening the front cover 120. The front cover 120 is openable and closable in order to enable a user to access the inside of the image forming apparatus 100. Accordingly, the user refills a cartridge with toner in a case where toner is used up, replaces a used-up process cartridge, or removes a jammed paper sheet in a case where a paper jam has occurred in the apparatus. FIG. 1 illustrates the apparatus in a state where the front cover 120 is open. In addition, whether or not the front cover 120 is open can be detected by a sensor (not illustrated) connected to a CPU 201 described later. Here, the front cover 120 is an example of a “cover”.

A display part 130 consisting of a liquid crystal display, and a copy glass 132 on which an original document to be scanned is placed are provided on an upper surface of the body apparatus 110. The display part 130 displays various information under control of the CPU 201. In addition, the display part 130 employs a touch panel type to function as an input part into which various conditions such as a paper sheet size and the number of copies related to image formation are input by an operation from the user. Specifically, in the present exemplary embodiment, a temporary clearing instruction for temporarily clearing an error for which a clearing method is displayed on the display part 130 can be input from the user. In addition, each time the temporary clearing instruction is received, the display part 130 displays clearing methods of errors subsequent to the error for which the temporary clearing instruction is received among errors that have occurred, in order in a switched manner. For example, in a case where three errors have occurred, and the temporary clearing instruction is received while a clearing method of an initial error is displayed, a clearing method of an error for which a clearing method is to be displayed for the second time is displayed on the display part 130. In a case where the temporary clearing instruction is received while the clearing method of the error for which the clearing method is to be displayed for the second time is displayed, a clearing method of an error for which a clearing method is to be displayed for the third time is displayed on the display part 130.

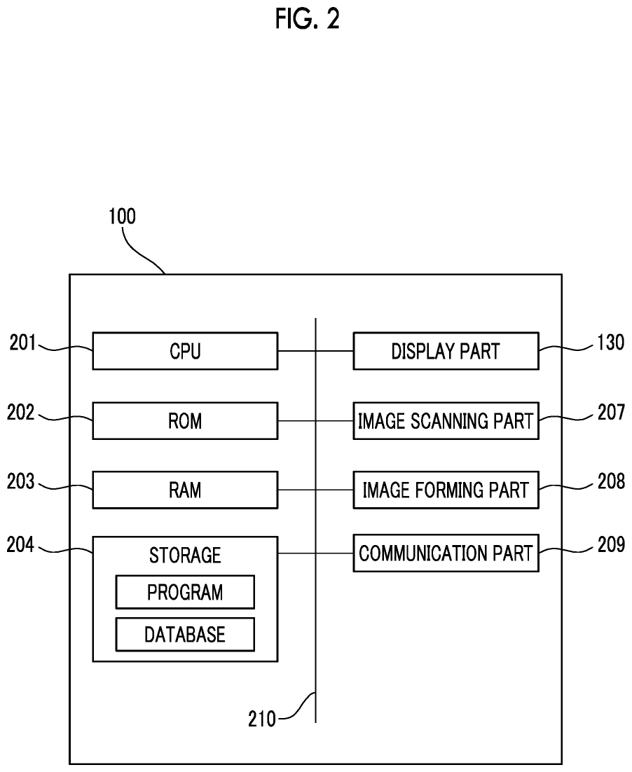

In addition, the body apparatus 110 includes, in an upper portion thereof, an automatic original document transport device 134 that transports the original document onto the copy glass 132. Furthermore, the body apparatus 110 includes an image scanning part 207 (refer to FIG. 2) that obtains image information by optically scanning the original document placed on the copy glass 132. The image information obtained by the image scanning part 207 is transmitted to an image forming part 208 (refer to FIG. 2). The image scanning part 207 is accommodated inside a casing 150 constituting a part of the body apparatus 110. In addition, the image forming part 208 is provided in the casing 150 as an attachable and detachable process cartridge 142. Attachment and detachment of the process cartridge 142 are performed by rotating an operation lever 144.

A toner accommodation part 146 is attached to the casing 150 of the body apparatus 110 and is refilled with toner from a toner supply port 148. The toner accommodated in the toner accommodation part 146 is supplied to a developing device.

Meanwhile, paper sheet accommodation cassettes 140a, 140b, and 140c are provided in a lower portion of the body apparatus 110. In addition, in the body apparatus 110, a transport path on which paper sheets of the paper sheet accommodation cassettes are transported to the image forming part 208 in the upper portion is formed by arranging a plurality of transport rollers each being configured with a pair of rollers in the apparatus. The paper sheets of each paper sheet accommodation cassette are withdrawn one sheet at a time by a paper sheet withdrawing mechanism disposed at an end of the transport path and are sent to the transport path. In addition, a manual feed paper sheet supply part 136 is provided on a side surface of the body apparatus 110, and a paper sheet is also supplied from the paper sheet supply part 136.

Paper sheets on which images are formed by the image forming part 208 are sequentially transported between two fixing rolls that are in contact with each other and that are supported by the casing 150 constituting a part of the body apparatus 110, and then, are discharged outside the body apparatus 110. In the body apparatus 110, a plurality of paper sheet discharge parts 138 are provided on an opposite side from a side on which the paper sheet supply part 136 is disposed, and the paper sheets after image formation are discharged to the paper sheet discharge parts.

Next, a hardware configuration of the image forming apparatus 100 will be described. FIG. 2 is a block diagram illustrating a hardware configuration of the image forming apparatus 100 according to the present exemplary embodiment.

As illustrated in FIG. 2, the image forming apparatus 100 includes the central processing unit (CPU) 201 that is an example of a processor, a read only memory (ROM) 202, a random access memory (RAM) 203, a storage 204, the display part 130, the image scanning part 207, the image forming part 208, and a communication part 209. These configurations are communicably connected to each other via a bus 210.

The CPU 201 is a central calculation processing unit and executes various programs or controls each part. That is, the CPU 201 reads a program from the ROM 202 or from the storage 204 and executes the program using the RAM 203 as a work region. The CPU 201 performs control of each of the above configurations and various calculation processing in accordance with the program recorded in the ROM 202 or in the storage 204. In the present exemplary embodiment, the program is stored in the storage 204.

The ROM 202 stores various programs and various data. The RAM 203 temporarily stores a program or data as the work region. The storage 204 is configured with a hard disk drive (HDD) or with a solid state drive (SSD) and stores various programs including an operating system and various data.

The image forming part 208 forms, that is, prints, on a recording medium such as paper, an image based on printing data included in a printing job obtained from a PC (not illustrated) connected via a network or on the image information obtained by scanning performed by the image scanning part 207.

The communication part 209 connects the image forming apparatus 100 to the network (not illustrated) and performs communication between the image forming apparatus 100 and other apparatuses such as the PC. In addition, the communication part 209 connects the image forming apparatus 100 to a public line and transmits and receives the image information obtained by scanning performed by the image scanning part 207 to and from other image forming apparatuses having a FAX function.

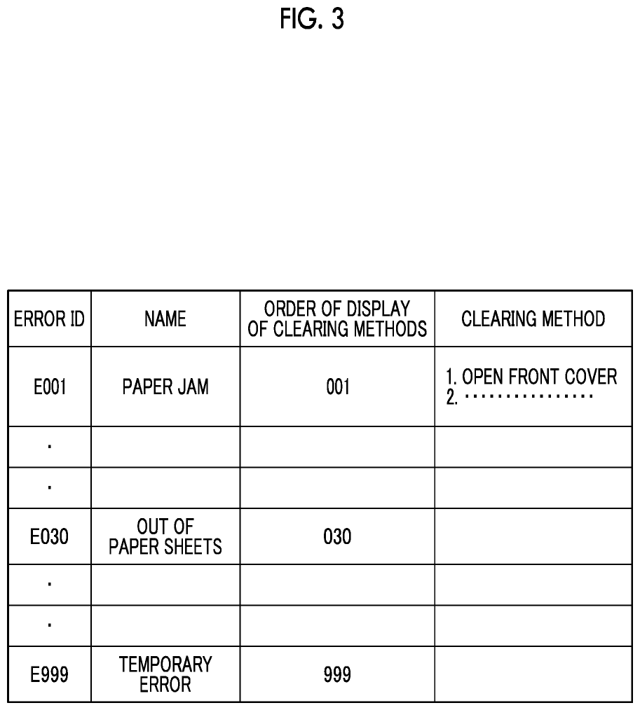

In addition, as illustrated in FIG. 3, the storage 204 stores a database in which an order of display of clearing methods for each error on the display part 130 and the clearing method of each error are registered. For example, an error “paper jam” is registered as an error ID “E001”, “001” is registered as an order of display of a clearing method of the error “paper jam” on the display part 130, and “open front cover” is registered as the clearing method.

Here, in the order of display of the clearing methods of the errors on the display part 130, a device error cleared by opening the front cover 120 of the image forming apparatus 100 is earlier in order than an operation error that is an error cleared with respect to a job. Examples of the device error include the error “paper jam”. Examples of the operation error include an error “out of paper sheets” that is an error clearable in a case where the user pauses the job. The present invention is not limited to a case where the device error is earlier in order than the operation error. The operation error that is earlier in order than the device error may be present.

In addition, a temporary error that is the last in the order of display of the clearing methods of the errors on the display part 130 is registered in the database. The temporary error is an error that, in a case where the errors have occurred, has not occurred but that is set to a state where the error has occurred, separately from the errors that have occurred. As will be described later, in the present exemplary embodiment, an error that has occurred can be temporarily cleared (hereinafter, referred to as “temporary clearing”). The temporary error is an error that is caused to occur in order to prevent the error from occurring again because of unintended resumption of processing of a job paused by the error in a case where temporary clearing of all errors is performed. Thus, in a case where all errors that have occurred are cleared, the temporary error is also cleared.

In addition, the clearing methods of the errors registered in the database are procedures that describe clearing procedures for each error using images or by voice.

Next, actions of the image forming apparatus 100 will be described.

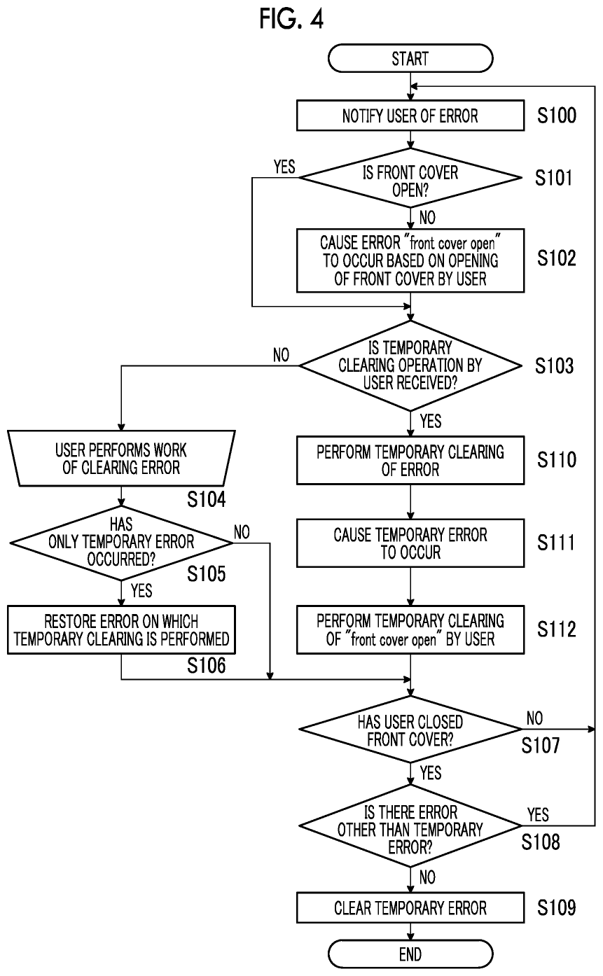

A flow of processing in clearing errors using the image forming apparatus 100 will be described using FIG. 4. A case where “paper jam” and “out of paper sheets” have occurred as the errors, and “paper jam” is an error earlier than “out of paper sheets” in the order of display of the clearing methods for clearing the errors on the display part 130 will be illustratively described with reference to FIG. 4.

In step S100 (first execution), the CPU 201 notifies the user of the errors that have occurred. In the present example, notification of an error earliest in order, that is, the occurrence of the error “paper jam” in the present example, among the errors that have occurred to the user is provided to the user using the display part 130 or a speaker (not illustrated), and a clearing method of the error “paper jam” is displayed on the display part 130. Then, a transition is made to next step S101. Here, the present invention is not limited to a case where notification of only the error earliest in order among the errors that have occurred is provided. Notification of all errors that have occurred may be provided, and only the clearing method of the error earliest in order may be displayed on the display part 130.

In step S101, the CPU 201 detects whether or not the front cover 120 is already open before the notification of the error in step S100. That is, whether or not the user has already opened the front cover 120 is detected. In a case where the front cover 120 is not detected as being already open, a transition is made to next step S102. In a case where the front cover 120 is detected as being already open, a transition is made to step S103 without passing through step S102. In the present example, since the user has not opened the front cover 120 yet, a transition is made to step S102.

In step S102, the CPU 201 detects the opening of the front cover 120 by the user and causes an error “front cover open” to occur based on the opening of the front cover 120 by the user. Then, a transition is made to next step S103.

In step S103, the CPU 201 determines whether or not a temporary clearing operation is received from the user. In a case where a determination that the temporary clearing operation is not received from the user is made, a transition is made to next step S104. In the present example, since the user is not performing an operation of clearing the error “paper jam”, a transition is made to next step S104 in which the temporary clearing operation is not received.

In step S104, the user performs an operation of clearing the error. In the present example, an operation of removing paper jammed in the inside or the like of the image forming apparatus 100 is performed in order to clear the error “paper jam”. Then, a transition is made to next step S105.

In step S105, the CPU 201 determines whether or not the processing is in a state where only the temporary error has occurred. In a case where a determination that the processing is in a state where only the temporary error has occurred is made, a transition is made to next step S106. In a case where a determination that the processing is in a state where only the temporary error has occurred is not made, a transition is made to step S107 without passing through step S106. In the present example, since the errors “paper jam”, “out of paper sheets”, and “front cover open” have occurred, and the processing is not in a state where only the temporary error has occurred, a transition is made to step S107.

In step S106, the CPU 201 receives an operation of clearing the temporary clearing by the user and restores errors on which the temporary clearing is performed. In the present example, since there is no error on which the temporary clearing is performed yet, a transition is made to next step S107 without restoring errors on which the temporary clearing is performed. The CPU 201 may clear the temporary clearing based on an elapse of time or the like without receiving the operation of clearing the temporary clearing by the user. In addition, notification that prompts the operation of clearing the temporary clearing by the user may be displayed on the display part 130.

In step S107, the CPU 201 determines whether or not the user has closed the front cover 120. In a case where a determination that the user has closed the front cover 120 is made, a transition is made to next step S120. In a case where a determination that the user has closed the front cover 120 is not made, a return is made to step S100. In the present example, since a determination that the user has closed the front cover 120 is not made, a return is made to step S100.

In step S100 (second execution), the CPU 201 notifies the user of the errors that have occurred. In the present example, the notification of the occurrence of the error “paper jam” notified in step S100 (first execution) is maintained. Then, a transition is made to next step S101.

In step S101, whether or not the front cover 120 is already open is detected. In the present example, since the front cover 120 is already open, a transition is made to step S103.

In step S103, the CPU 201 determines whether or not the temporary clearing operation is received from the user. In the present example, since the user is performing the operation of clearing the error “paper jam” in step S104, the temporary clearing operation of the error “paper jam” is received from the user. Thus, a transition is made to step S110.

In step S110, the CPU 201 performs the temporary clearing of the error. In the present example, the temporary clearing is performed on the error “paper jam” that is the error for which the clearing method is displayed on the display part 130. In addition, the CPU 201 stores information about the error on which the temporary clearing is performed. Then, a transition is made to next step S111.

In step S111, the CPU 201 causes the temporary error to occur. Then, a transition is made to next step S112.

In step S112, the CPU 201 receives the temporary clearing of the error “front cover open” by the user. Then, a transition is made to next step S107.

In step S107, the CPU 201 determines whether or not the user has closed the front cover 120. In a case where a determination that the user has closed the front cover 120 is made, a transition is made to next step S120. In a case where a determination that the user has closed the front cover 120 is not made, a return is made to step S100. In the present example, since a determination that the user has closed the front cover 120 is not made, a return is made to step S100.

In step S100 (third execution), the CPU 201 notifies the user of the errors that have occurred. In the present example, notification of the occurrence of the error “out of paper sheets” that is the error for which a clearing method is to be displayed next to the error “paper jam” out of the errors that have occurred is provided to the user, and the clearing method of the error “out of paper sheets” is displayed on the display part 130. Then, a transition is made to next step S101.

In step S101, whether or not the front cover 120 is already open is detected. In the present example, since the front cover 120 is already open, a transition is made to step S103.

In step S103, the CPU 201 determines whether or not the temporary clearing operation is received from the user. In a case where a determination that the temporary clearing operation is not received from the user is made, a transition is made to next step S104. In the present example, since the user is not performing an operation of clearing the error “out of paper sheets”, a transition is made to next step S104 in which the temporary clearing operation is not received.

In step S104, the user performs an operation of clearing the error. In the present example, an operation of pulling out and refilling the paper sheet accommodation cassettes 140a, 140b, and 140c not having paper sheets is performed in order to clear the error “out of paper sheets”. Then, a transition is made to next step S105.

In step S105, the CPU 201 determines whether or not the processing is in a state where only the temporary error has occurred. In a case where a determination that the processing is in a state where only the temporary error has occurred is made, a transition is made to next step S106. In a case where a determination that the processing is in a state where only the temporary error has occurred is not made, a transition is made to step S107 without passing through step S106. In the present example, since the errors “out of paper sheets” and “front cover open” have occurred, and the processing is not in a state where only the temporary error has occurred, a transition is made to step S107.

In step S106, the CPU 201 restores errors on which the temporary clearing is performed. In the present example, the error “paper jam” on which the temporary clearing is performed in step S110 and the error “front cover open” on which the temporary clearing is performed in step S112 are restored. Then, a transition is made to next step S107.

In step S107, the CPU 201 determines whether or not the user has closed the front cover 120. In a case where a determination that the user has closed the front cover 120 is made, a transition is made to next step S120. In a case where a determination that the user has closed the front cover 120 is not made, a return is made to step S100. In the present example, since a determination that the user has closed the front cover 120 is not made, a return is made to step S100.

In step S100 (fourth execution), the CPU 201 notifies the user of the errors that have occurred. In the present example, the notification of the occurrence of the error “out of paper sheets” notified in step S100 (third execution) is maintained. Then, a transition is made to next step S101.

In step S101, whether or not the front cover 120 is already open is detected. In the present example, since the front cover 120 is already open, a transition is made to step S103.

In step S103, the CPU 201 determines whether or not the temporary clearing operation is received from the user. In the present example, since the user is performing the operation of clearing the error “out of paper sheets” in step S104, the temporary clearing operation of the error “out of paper sheets” is received from the user. Thus, a transition is made to step S110.

In step S110, the CPU 201 performs the temporary clearing of the error. In the present example, the temporary clearing is performed on the error “out of paper sheets” that is the error for which the clearing method is displayed on the display part 130. Then, a transition is made to next step S111.

In step S111, the CPU 201 causes the temporary error to occur. Since the temporary error has already occurred, the temporary error may be maintained. Then, a transition is made to next step S112.

In step S112, the CPU 201 receives the temporary clearing of the error “front cover open” by the user. Then, a transition is made to next step S107.

In step S107, the CPU 201 determines whether or not the user has closed the front cover 120. In a case where a determination that the user has closed the front cover 120 is made, a transition is made to next step S120. In a case where a determination that the user has closed the front cover 120 is not made, a return is made to step S100. In the present example, since the user is performing an operation of clearing the errors “paper jam” and “out of paper sheets” that have occurred, a case where a determination that the front cover 120 is closed is made will be described. Thus, a transition is made to next step S108.

In step S108, the CPU 201 determines whether or not there is an error other than the temporary error. That is, whether an error other than the temporary error that has occurred in the image forming apparatus 100 is cleared by closing the front cover 120 as a trigger or other errors have occurred is checked. In a case where a determination that there is an error is made, a return is made to step S100. In a case where a determination that there is no error is made, a transition is made to next step S109. In the present example, since the errors “paper jam” and “out of paper sheets” have already been cleared by the user, and the error “front cover open” is also cleared by closing the front cover 120, a transition is made to step S109. In addition, since all errors are cleared, the CPU 201 deletes the stored information about the error on which the temporary clearing is performed.

In step S109, the CPU 201 clears the temporary error. Then, the processing ends. After clearing the temporary error, the CPU 201 resumes processing of a job paused by the errors, for example, processing such as copying or printing of which processing is paused by a paper jam or because of running out of paper sheets. That is, in a case where clearing operations for all clearing methods of the errors that have occurred are completed, the CPU 201 resumes the processing of the job paused by the errors.

According to the present disclosure, an effect of enabling a plurality of clearing operations for a plurality of errors to be collectively checked is achieved. Particularly, in a case where a clearing method for clearing an error that has occurred is performed by opening the front cover 120, the CPU 201 determines whether or not the error is cleared by closing the front cover 120 each time an operation of clearing one error is performed. Furthermore, in a case where whether or not other errors have occurred is determined, and other errors have occurred, the user is caused to perform an operation of opening the front cover 120 again. In a case where the user is caused to perform an operation of opening and closing the front cover 120 a plurality of times, the user is considered to feel unsatisfied, and a degree of satisfaction of the image forming apparatus 100 may be decreased. Thus, whether or not errors are cleared is collectively checked by an operation of opening and closing the front cover 120 once. In addition, in a case where all errors are temporarily cleared, the temporary error is caused to occur in order to prevent resumption of the processing of the job paused by the errors.

### Modification Example

The present invention is not limited to the above exemplary embodiment and can be subjected to various modifications and applications without departing from the gist of the invention.

While an aspect in which the program is stored (installed) in advance in the ROM 202 or in the storage 204 has been described in the exemplary embodiment, the present invention is not limited thereto. The program may be provided in the form of a recording on a recording medium such as a compact disk read only memory (CD-ROM), a digital versatile disk read only memory (DVD-ROM), and a universal serial bus (USB) memory. In addition, the program may be in the form of a download from an outside apparatus via a network N.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The following is further disclosed with respect to the above exemplary embodiment.

(((1)))

An image forming apparatus comprising:
a processor configured to:
   display a clearing method for clearing an initial error among errors that have occurred, on a display part;
   while the clearing method of the initial error of which the clearing method is displayed on the display part is displayed, receive a temporary clearing instruction for processing the initial error as being temporarily cleared;
   each time the temporary clearing instruction is received, display clearing methods of subsequent errors on the display part in order in a switched manner; and
   in a case where clearing operations for all clearing methods of the errors that have occurred are completed, resume processing of a job paused by the errors.

(((2)))

The image forming apparatus according to (((1))), wherein the processor is configured to:
store information about the temporarily cleared error and, in a case where all of the errors are temporarily cleared, restore the temporarily cleared errors.

(((3)))

The image forming apparatus according to (((1))) or (((2))), wherein the processor is configured to:
in a case where the errors have occurred, cause a temporary error that has not occurred but that is set to a state where the error has occurred, separately from the errors that have occurred; and
in a case where all of the errors that have occurred are cleared, clear the temporary error.

(((4)))

The image forming apparatus according to (((3))), wherein the processor is configured to:
after clearing the temporary error, resume the processing of the job paused by the errors.

(((5)))

The image forming apparatus according to any one of (((1))) to (((4))), further comprising:
a cover that is provided in a front portion of the image forming apparatus and through which an inside of the image forming apparatus is accessible by opening the cover,
wherein the clearing method for clearing the error is performed by opening the cover, and
the processor is configured to:
   in a case where the cover is closed, check whether or not the error is cleared.

(((6)))

The image forming apparatus according to (((2))), wherein the processor is configured to:
store the information about the temporarily cleared error until a determination that all of the errors that have occurred are cleared is made.

(((7)))

A non-transitory computer readable medium storing a program causing a computer to execute a process comprising:
displaying a clearing method for clearing an initial error among errors that have occurred, on a display part;
receiving, while the clearing method of the initial error of which the clearing method is displayed on the display part is displayed, a temporary clearing instruction for processing the initial error as being temporarily cleared;
displaying, each time the temporary clearing instruction is received, clearing methods of subsequent errors on the display part in order in a switched manner; and
resuming, in a case where clearing operations for all clearing methods of the errors that have occurred are completed, processing of a job paused by the errors.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a processor configured to:
display a clearing method for clearing an initial error among errors that have occurred, on a display part;
while the clearing method of the initial error of which the clearing method is displayed on the display part is displayed, receive a temporary clearing instruction for processing the initial error as being temporarily cleared;
each time the temporary clearing instruction is received, display clearing methods of subsequent errors on the display part in order in a switched manner; and
in a case where clearing operations for all clearing methods of the errors that have occurred are completed, resume processing of a job paused by the errors.

2. The image forming apparatus according to claim 1, wherein the processor is configured to:
store information about the temporarily cleared error and, in a case where all of the errors are temporarily cleared, restore the temporarily cleared errors.

3. The image forming apparatus according to claim 1, wherein the processor is configured to:
in a case where the errors have occurred, cause a temporary error that has not occurred but that is set to a state where the error has occurred, separately from the errors that have occurred; and
in a case where all of the errors that have occurred are cleared, clear the temporary error.

4. The image forming apparatus according to claim 3, wherein the processor is configured to:
after clearing the temporary error, resume the processing of the job paused by the errors.

5. The image forming apparatus according to claim 1, further comprising:
a cover that is provided in a front portion of the image forming apparatus and through which an inside of the image forming apparatus is accessible by opening the cover,
wherein the clearing method for clearing the error is performed by opening the cover, and
the processor is configured to:
in a case where the cover is closed, check whether or not the error is cleared.

6. The image forming apparatus according to claim 2, wherein the processor is configured to:
store the information about the temporarily cleared error until a determination that all of the errors that have occurred are cleared is made.

7. A non-transitory computer readable medium storing a program causing a computer to execute a process comprising:
displaying a clearing method for clearing an initial error among errors that have occurred, on a display part;
receiving, while the clearing method of the initial error of which the clearing method is displayed on the display part is displayed, a temporary clearing instruction for processing the initial error as being temporarily cleared;
displaying, each time the temporary clearing instruction is received, clearing methods of subsequent errors on the display part in order in a switched manner; and
resuming, in a case where clearing operations for all clearing methods of the errors that have occurred are completed, processing of a job paused by the errors.

8. An image forming method comprising:
displaying a clearing method for clearing an initial error among errors that have occurred, on a display part;
receiving, while the clearing method of the initial error of which the clearing method is displayed on the display part is displayed, a temporary clearing instruction for processing the initial error as being temporarily cleared;
displaying, each time the temporary clearing instruction is received, clearing methods of subsequent errors on the display part in order in a switched manner; and
resuming, in a case where clearing operations for all clearing methods of the errors that have occurred are completed, processing of a job paused by the errors.
